(19) United States
(12) Patent Application Publication
(10) Pub. No.: US 2026/0185315 A1
(43) Pub. Date: Jul. 2, 2026

(54) DEVICE FOR CLEANING A CONTACT LINE ASSEMBLY

(71) Applicant: SSR GmbH, Wilhering (AT)

(72) Inventor: Sascha Dini, Wilhering (AT)

(21) Appl. No.: 19/125,176

(22) PCT Filed: Sep. 7, 2023
(86) PCT No.: PCT/AT2023/060313

§ 371 Date: Apr. 28, 2025

(30) Foreign Application Priority Data
Oct. 31, 2022 (AT) A 50834/2022

(51) Int. Cl. E01H 8/10; B08B 1/30

(52) U.S. Cl. CPC E01H 8/105; B08B 1/30

(57) ABSTRACT

A device for cleaning a conductor rail system (1) with parallel current rails (13) arranged one above the other in a common plane on a support (14) has a carriage (2) that can be moved along the support (14). The carriage (2) has a cleaning head (4) with grinding elements (15) that grip into the current rails (13), which are U-shaped in cross-section and open on the side facing away from the support (14), and a suction device (6) with suction channels (21) opening into the conductor rails (13). The support (14) forms a roller track (25) for at least one pressure roller (24) associated with the cleaning head (4) and having an axis perpendicular to the common plane of the current rails (13). The pressure roller (24) is displaceably mounted in a loading head (26) against the force of a loading spring (27) in a stop-limited manner perpendicular to the roller track (25) and the loading head (26) can be driven perpendicular to the roller track (25) by a slider-crank mechanism (31).

### FIELD OF TECHNOLOGY

The invention relates to a device for cleaning a conductor rail system with parallel conductor rails arranged one above the other in a common plane on a support and with a carriage that can be moved along the support, which carriage has a cleaning head with grinding elements that grip into the conductor rails, which are U-shaped in cross-section and open on the side facing away from the support, and a suction device with suction channels opening into the conductor rails.

### STATE OF THE ART

In conductor rail systems, the current collectors with carbon brushes grip into the U-shaped conductor rails, which are open on one side. The unavoidable abrasion of the carbon brushes during operation leads to contamination of the contact rails and brings with it the risk of contact problems. For this reason, such conductor rail arrangements must be cleaned of deposits, in particular of carbon dust, at regular maintenance intervals. To avoid having to do this cleaning work by hand, various devices for cleaning such conductor rail systems have already been proposed. These known devices all have a carriage that can be moved along the support for the parallel conductor rails, with a cleaning head that is connected to a suction device, which is intended to suction the carbon dust deposited in the current rails and loosened by rotating brushes (DE 35 18 789 A1, DE 102 08 507 A1, DE 10 2010 013 364 A1). Instead of rotating brushes, driven grinding discs can also be used (DE 20 2018 101 460 U1). However, it has been shown that regardless of the rotating cleaning tools used, the cleaning result remains unsatisfactory because, in particular, coal dust deposited in the connection area of the individual conductor rail sections cannot be removed to a sufficient extent. This is also the case when the brush drive is frequency-controlled (DE 102 08 507 A1) in order to be able to transfer certain resonances to the conductor rails to be cleaned via the brush rotation.

To improve the cleaning result, it is known (DE 10 2004 008 572 A1) to equip the cleaning head with grinding elements that grip into the conductor rails and are provided with suction channels that open into the conductor rails, so that the deposits loosened from the conductor rails by the grinding elements can be effectively suctioned off. However, the disadvantage is that the grinding surfaces are reduced due to the suction channels opening in the area of the grinding surfaces, which has a negative effect on the cleaning result. Furthermore, the cleaning is limited to the removal of layers of deposits in the direct area of the grinding elements.

### DESCRIPTION OF THE INVENTION

The underlying objective of the invention is to develop a cleaning device for conductor rail systems in such a way that the deposits can be largely removed by the abrasion of the carbon brushes, even in areas of the conductor rail that cannot be accessed directly by an abrasive tool, as is the case, for example, in the connection area of conductor rail sections.

Based on a cleaning device of the aforementioned type, the invention solves the task by that the support forms a roller track for at least one pressure roller associated with the cleaning head and having an axis perpendicular to the common plane of the current rails, that the pressure roller is displaceably mounted in a loading head against the force of a loading spring in a stop-limited manner perpendicular to the roller track and that the loading head can be driven perpendicular to the roller track by a slider-crank mechanism.

Periodic pressurization and the associated elastic deformation of the support in the area of the cleaning head, in combination with the grinding elements, achieve extensive removal of the coal dust deposits in the U-shaped conductor rails, so that the parts loosened from the conductor rails can be removed from the conductor rails by means of the suction device. Since the pressure roller, which is displaceably mounted in the loading head, is held against the roller track of the support by the loading spring provided in the loading head, independently of the movement of the loading head, the movement of the loading head merely changes the preload of the loading spring periodically, with the effect the support is set into vibration via the roller track within the scope of its elastic behavior, which helps to loosen the deposits from the conductor rails. The mechanical loading of the loading head by a slider-crank mechanism allows for easy adjustment of the stroke frequency of the loading head, so that by selecting the stroke frequency in combination with a corresponding pre-tensioning of the loading spring, it is possible to adapt the cleaning device to the respective mechanical properties of the conductor rail system.

In order to be able to effectively suction off the loosened deposits from the conductor rails, the cleaning head can have a housing connected to the suction device, which has an insert with grinding elements that extend beyond the housing and grip into the conductor rails, and forms the suction channels on either side of the insert, which open into the conductor rails. Due to this measure, the particles can be suctioned off immediately after they have been loosened from the conductor rails and no longer deposit on the conductor rails. The suction channels opening into the conductor rails on both sides of the grinding elements, a simple suction of the loosened particles can be ensured independently of the direction of travel of the carriage.

The housing can be equipped with guide wheels that grip into the conductor rails to ensure that the cleaning head is aligned with the conductor rail system.

In order to ensure that the grinding elements are evenly positioned, regardless of any wear, the insert can have mountings for the grinding elements, which are displaceably mounted in the mountings against the force of pressure springs. The use of such an insert also makes it easier to replace the grinding elements when they are worn.

The abrasive effect of the grinding elements can be further improved if the housing of the cleaning head is equipped with at least one vibration motor. The vibrations of the housing caused by the vibration motor result in a periodic pressurization of the grinding elements, which improves the abrasive effect of the grinding elements.

To monitor the cleaning process, the carriage can have a digital surface sensor for the conductor rails and a control device which, depending on the surface data of the conductor rails detected by the surface sensor, switches the feed direction of the carriage and controls the cleaning head. According to these measures, the cleaning effect of the cleaning head can be verified, to repeat the cleaning process if necessary by moving the cleaning head back and forth over the dirty section of the conductor rail system several times if the cleaning is insufficient. Since the contamination of the conductor rails mainly occurs in the connection area of the individual conductor rail sections and these conductor rail connections are easy to access, the control effort required can be comparatively low.

If a contamination cannot be removed after a specified number of cleaning steps, the cleaning process can be interrupted and the contaminated area indicated. For this purpose, the carriage can have a marking device for the conductor rails that can be controlled by the control device depending on the recorded surface data of the conductor rails. For example, paint can be applied to the support or the conductor rails for marking.

### BRIEF DESCRIPTION OF THE INVENTION

The drawing shows the subject of the invention, for example.

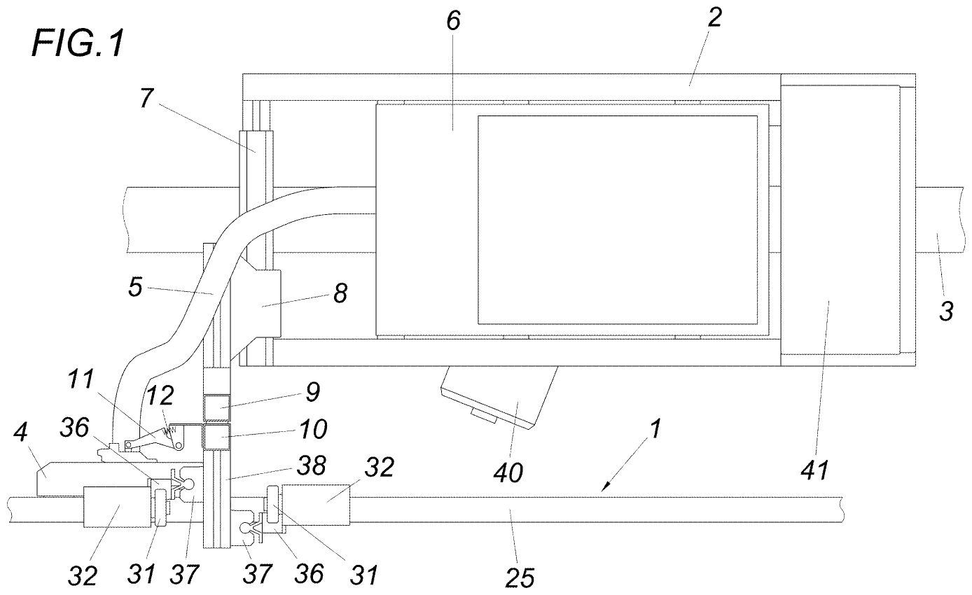

FIG. 1 shows a device according to the invention for cleaning a conductor rail system in a simplified plan view,

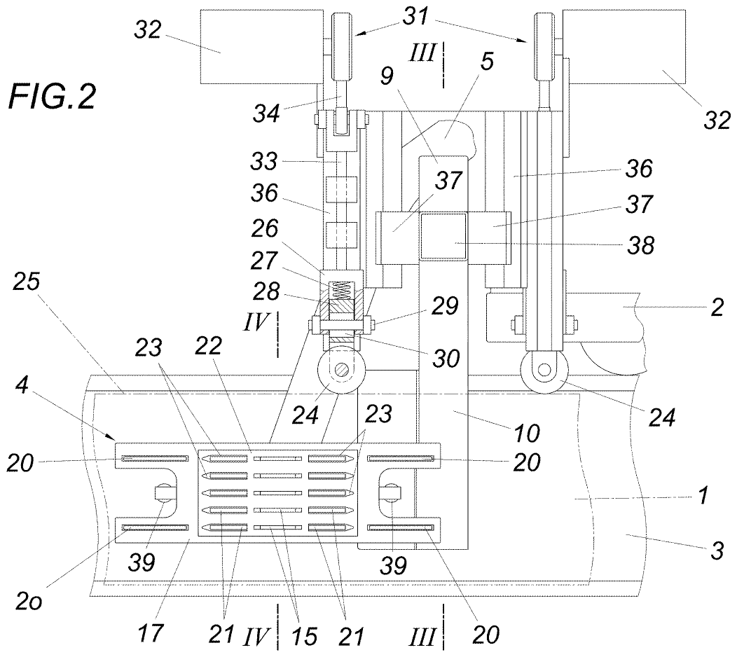

FIG. 2 shows the cleaning head of the device according to the invention in a partially opened view on the side facing the conductor rail system on a larger scale,

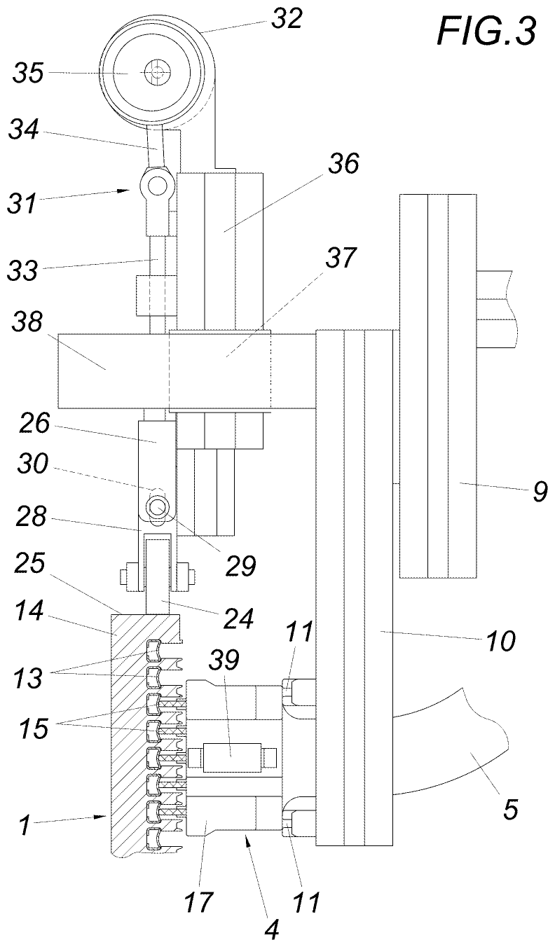

FIG. 3 shows a section on a larger scale, according to line III-III of FIG. 2,

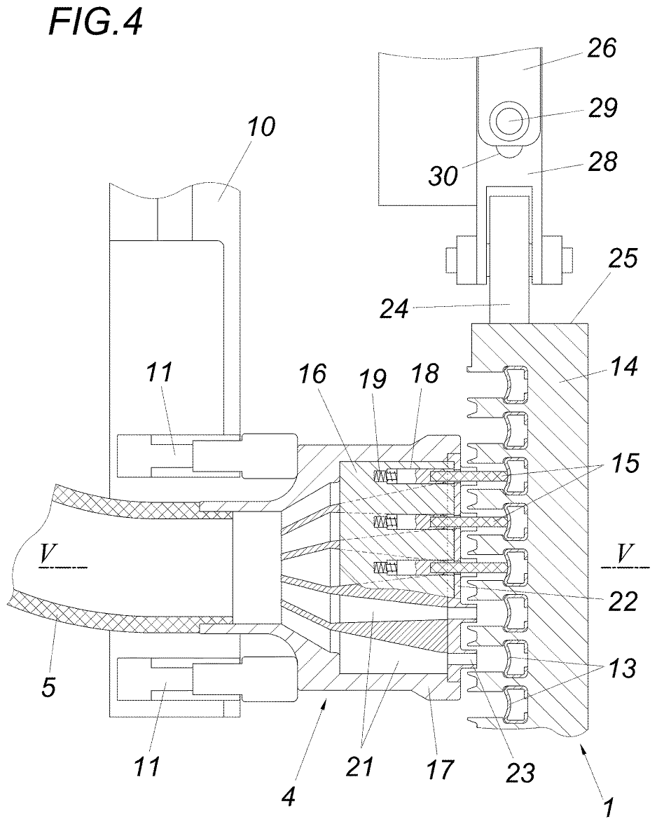

FIG. 4 shows a section on a larger scale according to line IV-IV of FIG. 2 and

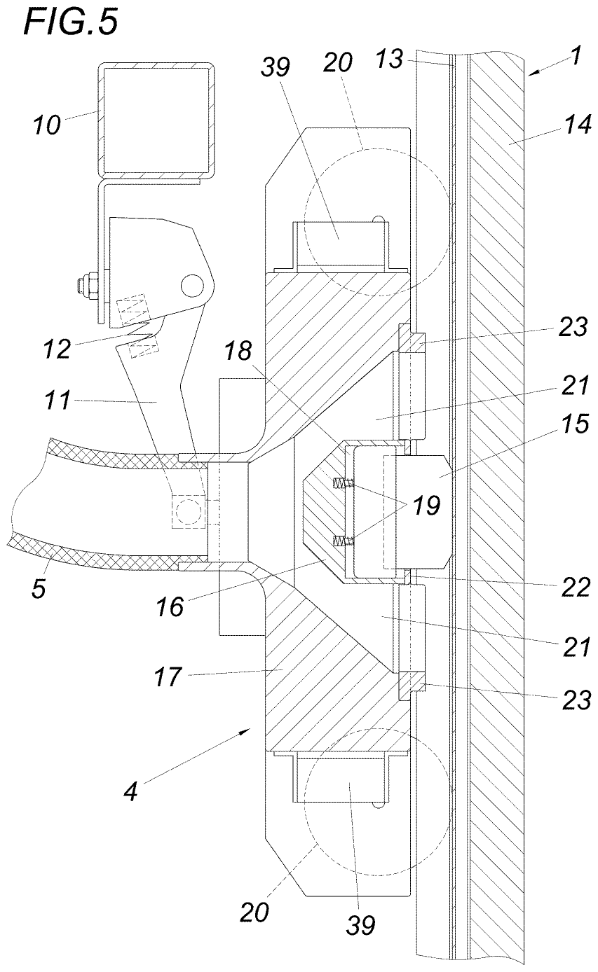

FIG. 5 shows a section according to the line V-V of FIG. 4.

### WAY OF IMPLEMENTING THE INVENTION

A device for cleaning a conductor rail system 1 according to the invention comprises a carriage 2 that can be moved along the conductor rail system 1, which, in the example, is driven on a rail arrangement 3 separate from the conductor rail system 1, but this is not mandatory. The carriage 2 is equipped with a cleaning head 4, which is connected to a suction device 6 by means of a tube 5.

A slide 8 that can be moved on a transverse guide 7 of the carriage 2 is provided to adjust the cleaning head 4 to the conductor rail system 1. The carriage has a lifting guide 9 for a lifting carriage 10, on which the cleaning head 4 is mounted using rods 11 that are loaded in the adjusting direction by adjusting springs 12. The cleaning head 4 is equipped with grinding elements 15 that grip into the conductor rails 13 for cleaning the U-shaped cross-section rails, which are arranged parallel to one another in a common plane on an electrically insulated support 14 and are open on the side facing away from the support 14 for the engagement of current collectors. These grinding elements 15 are provided in an insert 16 of a housing 17 of the cleaning head 4. The arrangement is such that the grinding elements 15 held in holders are guided in mountings 18 of the insert 16 so as to be displaceable perpendicular to the common plane of the conductor rails 13 by means of the holders and are loaded by pressure springs 19. In the working position shown, the cleaning head 4, which is held by the adjusting springs 12 in contact with the conductor rail system 1, is supported by guide wheels 20 mounted in the housing 17, which constructively define a predetermined distance between the cleaning head 4 and the conductor rails 13. The pressure springs 19 for the grinding elements 15 thus ensure a corresponding grinding pressure while compensating for any wear of the grinding elements 15.

To suction the deposit particles loosened from the conductor rails 13, suction channels 21 are formed in the housing 17 on the side next to the insert, which open into the conductor rails 13 and are supplied with negative pressure via the tube 5 connected to the suction device 6. The housing cover 22, which closes the housing 17 with respect to the conductor rail system 1, forms, in addition to the openings for the grinding elements 15, the mouths 23 for the suction channels 21 to grip into the conductor rails 13.

The cleaning head 4 connected to a suction device 6 is necessary for cleaning the conductor rails, but it is not sufficient on its own because the grinding elements 15 cannot loosen the deposits sufficiently from the conductor rails 13. For this reason, the support 14 receiving the conductor rails 13 is excited in the gripping area of the cleaning head 4 in addition to periodic vibrations in the elastic range. For this purpose, at least one pressure roller 24 is to be provided, which rolls on a roller track 25 of the support 14. According to the illustrated embodiment, two pressure rollers 24 are provided. Each of these pressure rollers 24 is mounted in a loading head 26 so that it can be displaced perpendicular to the roller track 25 and is loaded by a loading spring 27 provided in the loading head 26. For this purpose, a slot 30 is provided in the support body 28 for the pressure roller 24, through which a guide bolt 29 of the loading head 26 passes.

Since the loading head 26 is driven in a reciprocating manner by a slider-crank mechanism 31 by means of a motor 32, the pressure roller 24, which is held by the loading spring 27 between the loading head 26 and the support body 28 in contact with the roller track 25, is loaded with periodic pressure vibrations. The preload of the loading spring 27 changes with the movement of the loading head 26 relative to the pressure roller 24 supported on the roller track 25.

The connecting rod 34 of the slider-crank mechanism 31, which is attached to a push rod 33, is mounted on an eccentric 35 driven by the motor 32, which creates simple, space-saving construction conditions. In order to be able to take the respective spacing conditions into account, each pressure roller 24 with the slider-crank mechanism 31 is arranged on a slide 36, which is displaceably mounted in a lifting guide 37 and can be locked in different lifting positions. Since the lifting guide 37 is provided on a crossbeam 38 of the lifting carriage 10 for the cleaning head 4, the pressure roller 24 can additionally be displaced in height relative to the cleaning head 4 for fine adjustment. If the lifting guide 37 is also guided displaceably along the crossbeam 38, it is also possible to make an additional adjustment of the pressure rollers 24 in the axial direction, i.e. perpendicular to the common plane of arrangement of the conductor rails.

The cleaning effect of the cleaning head 4 can be improved by means of vibration motors 39, which are arranged on the housing 17 and ensure that the grinding elements 15 vibrate.

To monitor the cleaning, the carriage 2 can be equipped with a digital surface sensor 40, for example a three-dimensional digital scanner, which scans the conductor rails 13 in order to be able to detect, on the basis of the determined data of the conductor rail surfaces, deposits on the conductor rails 13 that are to be cleaned. By means of a control device 41, the feed direction of the carriage 2 can then be repeatedly switched, if necessary, depending on the surface data recorded, to repeat the cleaning process until the surface data indicates that the conductor rails 13 have been cleaned sufficiently. If such cleaning is not achieved within a predetermined sequence of cleaning steps, the control device can indicate the contaminated location, preferably by color-coding the contaminated conductor rail area.

1. A device for cleaning a conductor rail system with parallel conductor rails arranged one above the other in a common plane on a support, said device comprising:
a carriage supported for movement along the support, said carriage having
a cleaning head with grinding elements that grip into the conductor rails, wherein the grinding elements are U-shaped in cross-section and open on side thereof facing away from the support, and
a suction device having suction channels opening into the conductor rails;
wherein the support forms a roller track supporting at least one pressure roller associated with the cleaning head;
said roller track having an axis perpendicular to the common plane of the conductor rails;
wherein the pressure roller is displaceably mounted in a loading head against a force of a loading spring in a stop-limited manner perpendicular to the roller track; and
wherein the loading head is supported so as to be driven perpendicular to the roller track by a slider-crank mechanism.

2. The device according to claim 1, wherein the cleaning head has a housing connected to the suction device, and said housing has an insert with the grinding elements that extend beyond the housing and grip into the conductor rails, and the housing forms the suction channels on either side of the insert, wherein the suction channels open into the conductor rails.

3. The device according to claim 2, wherein the housing has guide wheels that grip into conductor rails.

4. The device according to claim 2, wherein the insert has mountings supporting the grinding elements the grinding elements being displaceably mounted in the mountings against a force of pressure springs.

5. The device according to claim 2, wherein the housing of the cleaning head has at least one vibration motor.

6. The device according to claim 1, wherein the carriage has a digital surface sensor sensing the conductor rails and a control device that, based on surface data of the conductor rails detected by the surface sensor, switches a feed direction of the carriage and controls the cleaning head.

7. The device according to claim 6, wherein the carriage has a marking device for the conductor rails that is configured to be controlled by the control device based on the detected surface data of the conductor rails.

8. The device according to claim 3, wherein the insert has mountings supporting the grinding elements, the grinding elements being displaceably mounted in the mountings against a force of pressure springs.

9. The device according to claim 3, wherein the housing of the cleaning head has at least one vibration motor.

10. The device according to claim 2, wherein the carriage has a digital surface sensor sensing the conductor rails and a control device that, based on surface data of the conductor rails detected by the surface sensor, switches a feed direction of the carriage and controls the cleaning head.

11. The device according to claim 3, wherein the carriage has a digital surface sensor sensing the conductor rails and a control device that, based on surface data of the conductor rails detected by the surface sensor, switches a feed direction of the carriage and controls the cleaning head.

12. The device according to claim 4, wherein the carriage has a digital surface sensor sensing the conductor rails and a control device that, based on surface data of the conductor rails detected by the surface sensor, switches a feed direction of the carriage and controls the cleaning head.

13. The device according to claim 8, wherein the carriage has a digital surface sensor sensing the conductor rails and a control device that, based on surface data of the conductor rails detected by the surface sensor, switches a feed direction of the carriage and controls the cleaning head.

14. The device according to claim 10, wherein the carriage has a marking device for the conductor rails that is configured to be controlled by the control device based on the detected surface data of the conductor rails.

15. The device according to claim 11, wherein the carriage has a marking device for the conductor rails that is configured to be controlled by the control device based on the detected surface data of the conductor rails.

16. The device according to claim 12, wherein the carriage has a marking device for the conductor rails that is configured to be controlled by the control device based on the detected surface data of the conductor rails.

17. The device according to claim 13, wherein the carriage has a marking device for the conductor rails that is configured to be controlled by the control device based on the detected surface data of the conductor rails.
